(19) United States
(12) Patent Application Publication
(10) Pub. No.: US 2008/0274396 A1
(43) Pub. Date: Nov. 6, 2008

(54) Battery Vent

(76) Inventors: Robert Lyle Routson, Quakertown, PA (US); Edwin A. Fink, Fleetwood, PA (US)

Correspondence Address: BARLEY SNYDER, LLC, 1000 WESTLAKES DRIVE, SUITE 275, BERWYN, PA, 19312, US

(21) Appl. No.: 12/113,490

(22) Filed: May 1, 2008

Related U.S. Application Data
(60) Provisional application No. 60/915,209, filed on May 1, 2007.

(51) Int. Cl. H01M 2/12

(52) U.S. Cl. 429/82

(57) ABSTRACT

A battery vent comprising a chamber bounded by a sidewall and a plate. In the chamber, a frit housing has a retainer wall extending from the plate into the chamber to an open retainer wall lower face. A vent tube extends outwardly from the frit housing and has a vent channel which is open to the retainer wall inside face. A frit is applied over the open retainer wall lower face and secured thereto by over molding.

### CROSS-REFERENCE TO RELATED APPLICATIONS

This application claims the benefit of the filing date under 35 U.S.C. §119(a)-(d) of Patent Application No. 60/915,209, filed May 1, 2007.

### FIELD OF THE INVENTION

The present invention is related to the field of batteries. More specifically, the present invention is related to the field of venting gases associated with batteries.

### BACKGROUND

It is not uncommon for conventional battery vents to be constructed in a multistep process. For example, battery vents are often constructed by forming a first piece of a battery vent and subsequently hot plate welding, adhering, press fit, or ultrasonically welding additional pieces to the first piece. Specifically, after the first piece is constructed, it is common for a flame suppression device, often referred to as a frit, to be associated with the first piece in a particular position and subsequently secured in that particular position by hot plate welding, adhering, press fit, or ultrasonically welding additional pieces to the first piece, where the additional pieces act to retain the frit in relation to the first piece. Further, it is common for a battery vent to be sealingly associated with a battery cover and/or battery case by hot plate welding, adhering, press fit, or ultrasonically welding the battery vent to the battery cover and/or battery case. The current methods of constructing battery vents, retaining a frit in a battery vent, and associating a battery vent with a battery cover and/or battery case are time and equipment intensive and often require inconvenient additional steps to accomplish the above-listed tasks.

### SUMMARY

In view of the problems with the current state of the art described above, the invention provides a battery vent comprising a chamber bounded by a sidewall and a plate. In the chamber, a frit housing has a retainer wall extending from the plate into the chamber to an open retainer wall lower face. A vent tube extends outwardly from the frit housing and has a vent channel which is open to the retainer wall inside face. A frit is applied over the open retainer wall lower face and secured thereto by over molding.

### BRIEF DESCRIPTION OF THE DRAWINGS

FIG. 1 is an oblique view of a battery vent in a partially constructed state according to an embodiment of the present invention;

FIG. 2 is an orthogonal bottom view of the battery vent of FIG. 1;

FIG. 3 is an orthogonal side view of the battery vent of FIG. 1;

FIG. 4 is an orthogonal top view of the battery vent of FIG. 1;

FIG. 5 is an oblique view of the battery vent of FIG. 1 in a fully constructed state;

FIG. 6 is an orthogonal bottom view of the battery vent of FIG. 1 in a fully constructed state;

FIG. 7 is an oblique view of a battery vent in a partially constructed state according to another embodiment of the present invention;

FIG. 8 is an orthogonal bottom view of the battery vent of FIG. 7;

FIG. 9 is an orthogonal side view of the battery vent of FIG. 7;

FIG. 10 is an orthogonal top view of the battery vent of FIG. 7;

FIG. 11 is an oblique view of the battery vent of FIG. 7 in a fully constructed state;

FIG. 12 is an orthogonal bottom view of the battery vent of FIG. 7 in a fully constructed state;

FIG. 13 is an oblique view of a battery vent in a partially constructed state according to another embodiment of the present invention;

FIG. 14 is an orthogonal bottom view of the battery vent of FIG. 13;

FIG. 15 is an orthogonal side view of the battery vent of FIG. 13;

FIG. 16 is an orthogonal top view of the battery vent of FIG. 13;

FIG. 17 is an oblique view of the battery vent of FIG. 13 in a fully constructed state; and

FIG. 18 is an orthogonal bottom view of the battery vent of FIG. 13 in a fully constructed state.

### DETAILED DESCRIPTION OF THE EMBODIMENTS

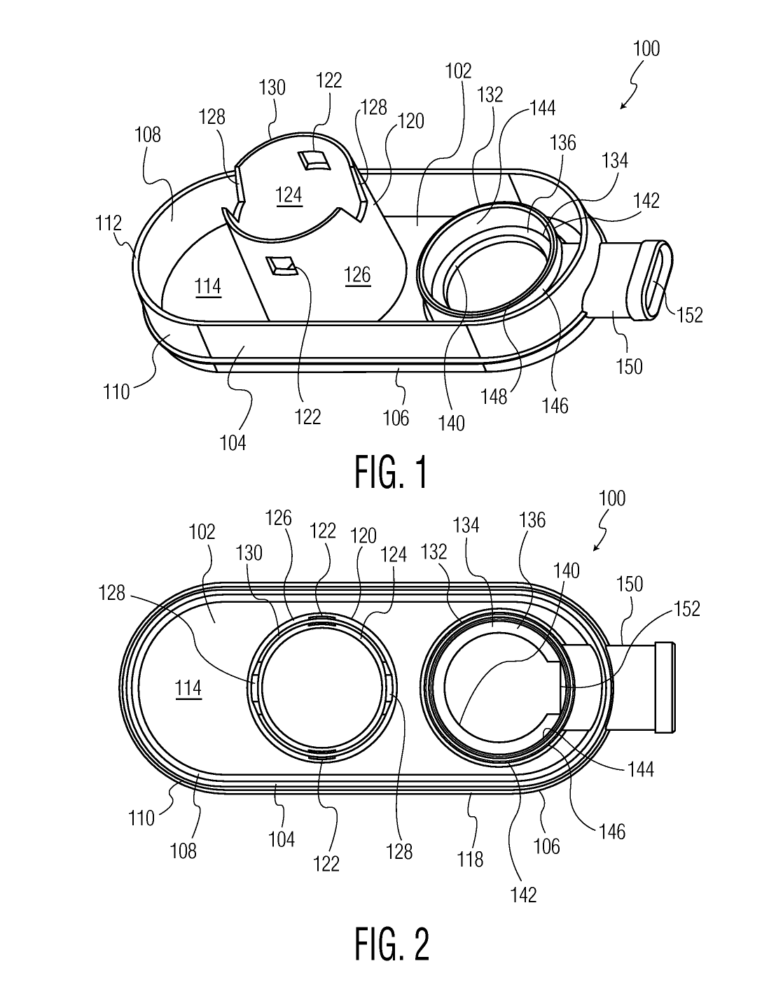

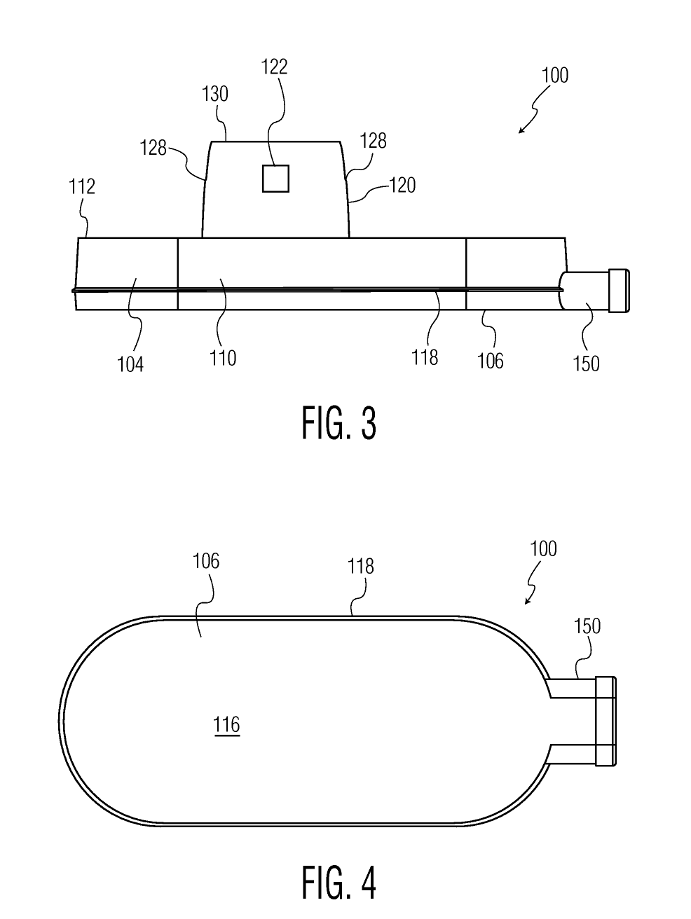

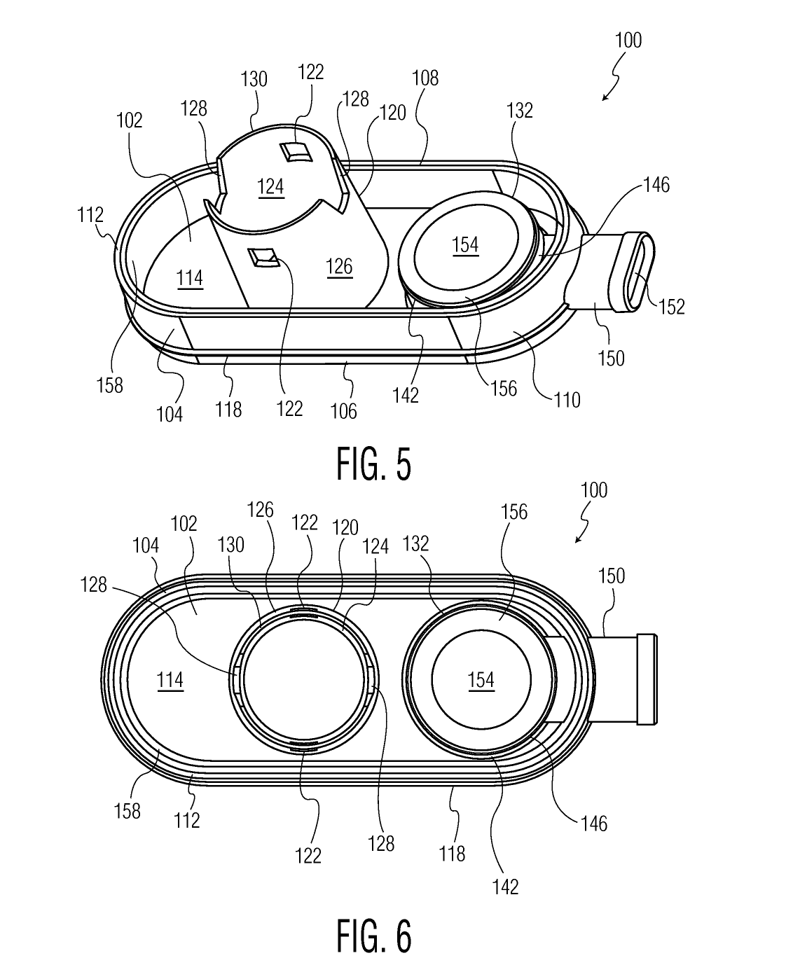

Referring to FIGS. 1-6, a battery vent 100 according to an embodiment of the present invention is illustrated. More specifically, the battery vent 100 is shown in a partially constructed state in FIGS. 1-4 while the battery vent 100 is shown in a fully constructed state in FIGS. 5 and 6.

Referring now to FIGS. 1-4, the battery vent 100 comprises a chamber 102 bounded generally by a sidewall 104 and a plate 106 that is attached to the sidewall 104. Sidewall 104 is generally upstanding with a periphery that approximates a ‘racetrack’ or two truncated circles joined by straight lines. The sidewall 104 comprises a sidewall inner face 108, a sidewall outer face 110, and a sidewall lower face 112. A sidewall upper face (not shown) is generally abutted and attached to a plate inner face 114 of plate 106. When assembled with the remainder of a battery (not shown), a plate outer face 116 is exposed to the environment exterior to the battery. The plate 106 is generally a flat member of constant thickness and comprises a periphery that approximates a ‘racetrack’ or two truncated circles joined by straight lines. As shown attached to the sidewall 104, the plate 106 generally extends to the periphery of the sidewall 104 and a seating lip 118 is formed substantially at the intersection of the sidewall 104 and the plate 106. The seating lip 118 may serve to interface a shoulder or other stop of a battery cover (not shown). Sidewall 104 has a varying thickness and is generally thickest near plate 106 and thinnest at sidewall lower face 112.

A retainer barrel 120 extends from the plate inner face 114 through the chamber 102 and beyond the sidewall lower face 112. The retainer barrel 120 is generally shaped as a frusto-conical tube where the larger diameter portion of the frustum is attached to the plate inner face 114 and the smaller diameter portion of the frustum lies outside the chamber 102 and beyond the sidewall lower face 112. The retainer barrel 120 comprises a barrel inner face 124 and a barrel outer face 126. Two diametrically opposing apertures 122 are formed in the retainer barrel 120 through the tubular wall, extending between a barrel inner face 124 and a barrel outer face 126. The apertures 122 are generally rectangular. Further, two diametrically opposing slots 128 are formed in the retainer barrel 120, also extending between the barrel inner face 124 and the barrel outer face 126. Each slot 128 is generally shaped as a truncated V where the open portion of the V is generally coplanar with a barrel lower face 130.

A generally cylindrical frit housing 132 is adjacent the retainer barrel 120 and extends from the plate inner face 114. However, unlike the retainer barrel 120, the frit housing 132 does not extend beyond the sidewall lower face 112, but is generally housed within the chamber 102. The frit housing 132 comprises a generally C-shaped frit shelf 134 that is attached to the plate inner face 114 and is positioned along a frit retainer wall inside face 144. The frit shelf 134 is oriented such that the open portion of the C-shape is directed away from the retainer barrel 120 along the length of the battery vent 100 and toward a longitudinal end of the battery vent 100. A frit retainer wall 142 is generally shaped as a short cylindrical tube having the frit retainer wall inside face 144, a frit retainer wall outer face 146, and a frit retainer wall lower face 148. Frit retainer wall 142 further comprises a frit retainer wall upper face (not shown) that is attached to the frit shelf lower face 136. Frit retainer wall 142 is generally coaxial with frit shelf 134. The diameter of the frit shelf inner face 140 is less than the diameter of the frit retainer wall inside face 144 while the diameter of the frit shelf outer face (not shown) is the same as the diameter of the frit retainer wall inside face 144.

A vent tube 150 for providing a vent channel 152 extends from the frit retainer wall 142, through the sidewall 104, and protrudes beyond the sidewall outer face 110. The vent tube 150 is generally shaped as an elongated tube having a ‘racetrack’ cross-sectional shape. Accordingly, the vent tube 150 provides the vent channel 152 that connects the environment exterior to the battery vent 100 and an associated battery vent cover (not shown) to the space generally bounded by the frit shelf inner face 140 and the plate inner face 114. The vent channel 152 is well suited for passing gas between the environment exterior to the battery vent 100 and an associated battery vent cover (not shown) and the space generally bounded by the frit shelf inner face 140 and the plate inner face 114.

The portions of battery vent 100 shown in FIGS. 1-4 may be constructed as a unitary piece as the result of an injection molding process. More specifically, the portions of battery vent 100 shown in FIGS. 1-4 may be formed of polypropylene or other suitable molding materials in a single injection-molding step. However, the portions of battery vent 100 shown in FIGS. 1-4 may alternatively be formed by joining a plurality of distinct pieces together to form the battery vent 100 as shown in FIGS. 1-4. While the battery vent 100 as shown in FIGS. 1-4 have been described with specificity, the shapes and relative sizes of the various features of the battery vent 100 as shown in FIGS. 1-4 may be altered without straying from the inventive concepts of the invention.

Referring now to FIGS. 5 and 6, the battery vent 100 is shown in a fully assembled state. After partial construction of the battery vent 100 as shown in FIGS. 1-4, a frit 154 may be assembled to the partially constructed battery vent 100. The frit 154 is generally a flame or spark arrestor which retards the ignition of gases which may pass through the vent channel 152. The frit 154 may be constructed of porous polyethylene, porous polypropylene, or any other suitable material capable of retarding the ignition of gases passing through the vent channel 152. The frit 154 is generally disc-shaped and is complementarily sized for insertion into the frit housing 132. More specifically, the frit 154 is configured to fit within the space generally bounded by the frit shelf lower face 136 and the frit retainer wall inside face 144. After insertion of the frit 154 into the frit housing 132, gas must pass through the frit 154 to travel between the chamber 102 and the vent channel 152.

After the frit 154 is installed into the frit housing 132, a second molding process may be utilized to secure the frit 154 in the frit housing 132 and to provide a compliant surface for allowing an interference fit seal between the sidewall inner face 108 and a complementary wall of a battery cover (not shown). First, thermoplastic rubber may be over-molded onto the frit retainer wall lower face 148 (which serves as a polypropylene substrate) and the portions of the frit 154 itself that are closely associated with the frit retainer wall lower face 148 to form a frit seal 156. The frit seal 156 is generally washer-shaped (the form of a disc with a central circular aperture) and serves to extend from the frit retainer wall lower face 148 over the edges of the frit 154 to retain the frit 154 in position within the frit housing 132. Of course, other portions of the frit retainer wall 142 and frit 154 may be over-molded to cause the desired retention of the frit 154 within the frit housing 132. By producing the frit seal through over-molding, cumbersome and expensive processes such as ultrasonic welding, hot plate melting, or other forms of adhesion are avoided. Further, the injection molding process for forming the battery vent 100 can be reduced to a simple two shot process where the polypropylene (or other suitable over-molding substrate) portion of the battery vent 100 (shown in FIGS. 1-4) is produced in a first shot and the frit seal and a vent seal 158 (discussed infra) are produced by injection of thermoplastic rubber in a second over-molded shot. Of course, where this two shot process is used, the frit 154 is inserted into the frit housing 132 between the occurrence of the first shot and the second shot.

As mentioned above, the battery vent 100 further comprises a vent seal 158 which serves as an intermediary compliant substance between the sidewall inner face 108 and a battery cover (not shown) during an interference fit between the two. More specifically, during the second shot of the two shot injection molding process described above, the vent seal 158 is deposited on the sidewall inner face 108. The vent seal 158 is formed of thermoplastic rubber (as is the frit seal 156) and is shaped as a wall having substantially uniform thickness extending from the plate inner face 114 to the sidewall lower face 112.

In operation, the battery vent 100 is used to interface a battery cover (not shown). More specifically, the sidewall 104 and associated vent seal 158 are placed in an interference fit with complementary walls of a battery cover (not shown) in such a manner that the vent seal 158 prevents unintentional escape of the battery gasses between the battery cover and the sidewall 104. Instead, the gases are allowed to escape the battery through a vent hole (not shown) in the battery cover into the chamber 102, subsequently through the frit 154, and finally through the vent channel 152. Of course, gases may be allowed to enter the battery through the same path but in reverse order, effectively allowing the battery to breath. Further, as the battery vent 100 is finally positioned relative to the complementary battery cover, locking tabs (not shown) on the battery cover engage apertures 122 to lock the battery vent 100 in place. Slots 128 serve to allow elastic deformation of the retainer barrel 120 as necessary to engage the locking tabs.

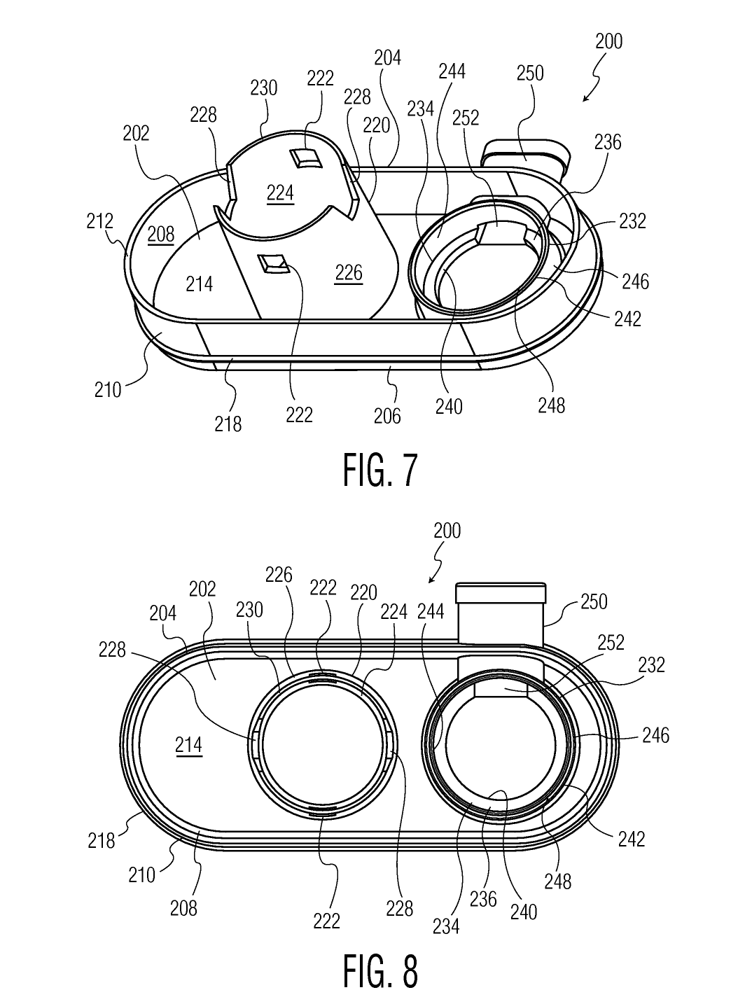

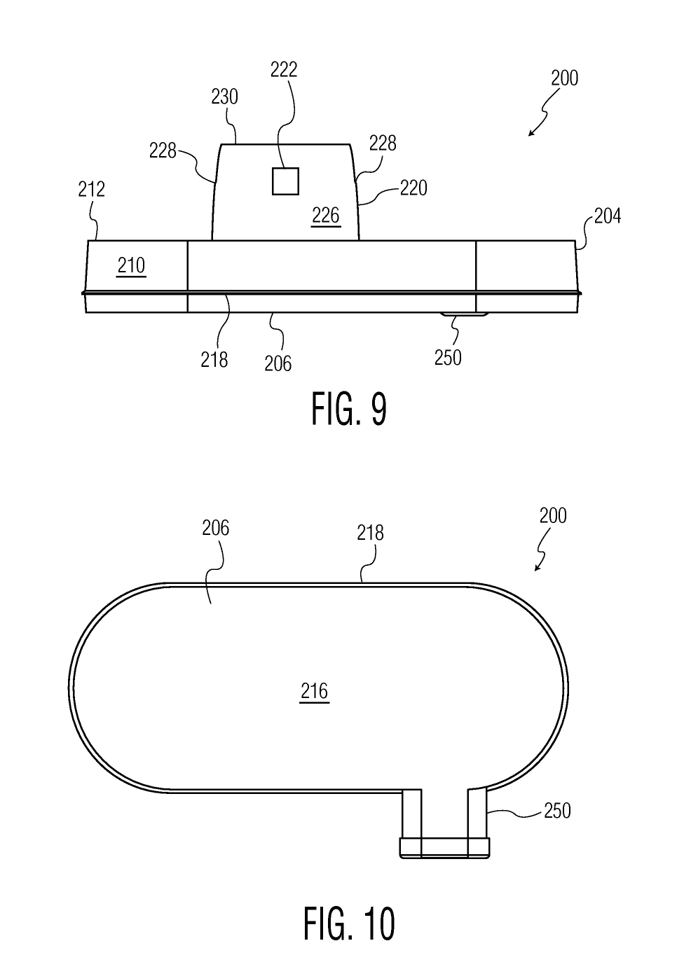

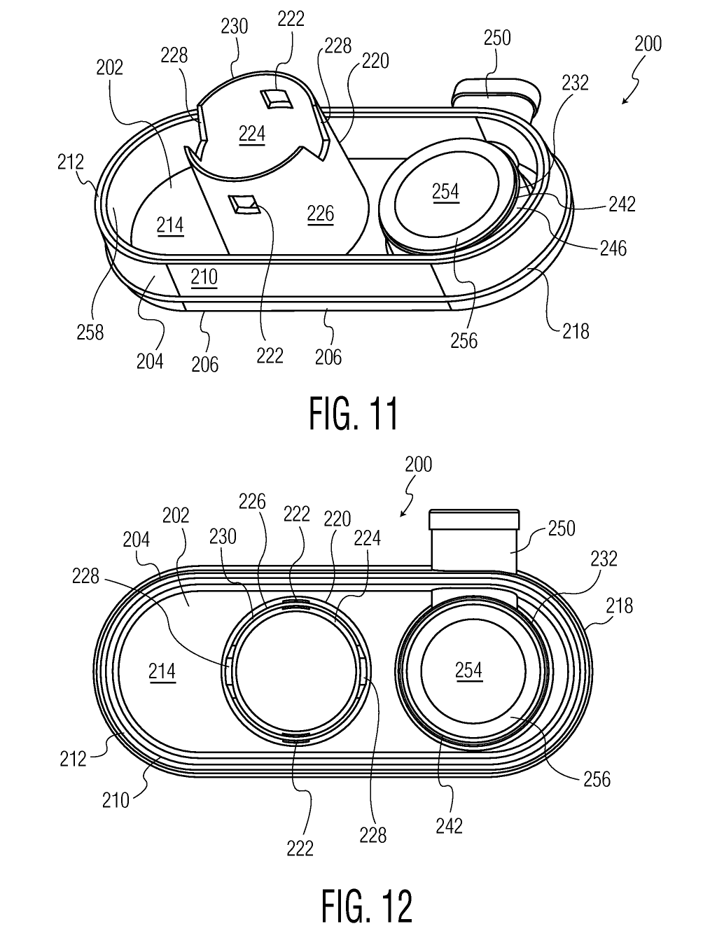

Referring to FIGS. 7-12, a battery vent 200 according to another embodiment of the present invention is illustrated. More specifically, the battery vent 200 is shown in a partially constructed state in FIGS. 7-10 while the battery vent 200 is shown in a fully constructed state in FIGS. 11 and 12.

Referring now to FIGS. 7-10, the battery vent 200 comprises a chamber 202 bounded generally by a sidewall 204 and a plate 206 that is attached to the sidewall 204. Sidewall 204 is generally upstanding with a periphery that approximates a ‘racetrack’ or two truncated circles joined by straight lines. The sidewall 204 comprises a sidewall inner face 208, a sidewall outer face 210, and a sidewall lower face 212. A sidewall upper face (not shown) is generally abutted and attached to a plate inner face 214 of plate 206. When assembled with the remainder of a battery (not shown), a plate outer face 216 is exposed to the environment exterior to the battery. The plate 206 is generally a flat member of constant thickness and comprises a periphery that approximates a ‘racetrack’ or two truncated circles joined by straight lines. As shown attached to the sidewall 204, the plate 206 generally extends to the periphery of the sidewall 204 and a seating lip 218 is formed substantially at the intersection of the sidewall 204 and the plate 206. The seating lip 218 may serve to interface a shoulder or other stop of a battery cover (not shown). Sidewall 204 has a varying thickness and is generally thickest near plate 206 and thinnest at sidewall lower face 212.

A retainer barrel 220 extends from the plate inner face 214 through the chamber 202 and beyond the sidewall lower face 212. The retainer barrel 220 is generally shaped as a frusto-conical tube where the larger diameter portion of the frustum is attached to the plate inner face 214 and the smaller diameter portion of the frustum lies outside the chamber 202 and beyond the sidewall lower face 212. The retainer barrel 220 comprises a barrel inner face 224 and a barrel outer face 226. Two diametrically opposing apertures 222 are formed in the retainer barrel 220 through the tubular wall, extending between a barrel inner face 224 and a barrel outer face 226. The apertures 222 are generally rectangular. Further, two diametrically opposing slots 228 are formed in the retainer barrel 220, also extending between the barrel inner face 224 and the barrel outer face 226. Each slot 228 is generally shaped as a truncated V where the open portion of the V is generally coplanar with a barrel lower face 230.

A generally cylindrical frit housing 232 is adjacent the retainer barrel 220 and extends from the plate inner face 214. However, unlike the retainer barrel 220, the frit housing 232 does not extend beyond the sidewall lower face 212, but is generally housed within the chamber 202. The frit housing 232 comprises a generally C-shaped frit shelf 234 that is attached to the plate inner face 214 and is positioned along a frit retainer wall inside face 244. The frit shelf 234 is oriented such that the open portion of the C-shape is directed toward a lateral side of the battery vent 200. A frit retainer wall 242 is generally shaped as a short cylindrical tube having the frit retainer wall inside face 244, a frit retainer wall outer face 246, and a frit retainer wall lower face 248. Frit retainer wall 242 further comprises a frit retainer wall upper face (not shown) that is attached to the frit shelf lower face 236. Frit retainer wall 242 is generally coaxial with frit shelf 234. The diameter of the frit shelf inner face 240 is less than the diameter of the frit retainer wall inside face 244 while the diameter of the frit shelf outer face (not shown) is the same as the diameter of the frit retainer wall inside face 244.

A vent tube 250 for providing a vent channel 252 extends from the frit retainer wall 242, through the sidewall 204, and protrudes beyond the sidewall outer face 210 in a lateral direction with respect to the length of the battery vent 100. The vent tube 250 is generally shaped as an elongated tube having a ‘racetrack’ cross-sectional shape. Accordingly, the vent tube 250 provides the vent channel 252 that connects the environment exterior to the battery vent 200 and an associated battery vent cover (not shown) to the space generally bounded by the frit shelf inner face 240 and the plate inner face 214. The vent channel 252 is well suited for passing gas between the environment exterior to the battery vent 200 and an associated battery vent cover (not shown) and the space generally bounded by the frit shelf inner face 240 and the plate inner face 214.

The portions of battery vent 200 shown in FIGS. 7-10 may be constructed as a unitary piece as the result of an injection molding process. More specifically, the portions of battery vent 200 shown in FIGS. 7-10 may be formed of polypropylene or other suitable molding materials in a single injection-molding step. However, the portions of battery vent 200 shown in FIGS. 7-10 may alternatively be formed by joining a plurality of distinct pieces together to form the battery vent 200 as shown in FIGS. 7-10. While the battery vent 200 as shown in FIGS. 7-10 have been described with specificity, the shapes and relative sizes of the various features of the battery vent 200 as shown in FIGS. 7-10 may be altered without straying from the inventive concepts of the invention.

Referring now to FIGS. 11 and 12, the battery vent 200 is shown in a fully assembled state. After partial construction of the battery vent 200 as shown in FIGS. 7-10, a frit 254 may be assembled to the partially constructed battery vent 200. The frit 254 is generally a flame or spark arrestor which retards the ignition of gases which may pass through the vent channel 252. The frit 254 may be constructed of porous polyethylene, porous polypropylene, or any other suitable material capable of retarding the ignition of gases passing through the vent channel 252. The frit 254 is generally disc-shaped and is complementarily sized for insertion into the frit housing 232. More specifically, the frit 254 is configured to fit within the space generally bounded by the frit shelf lower face 236 and the frit retainer wall inside face 244. After insertion of the frit 254 into the frit housing 232, gas must pass through the frit 254 to travel between the chamber 202 and the vent channel 252.

After the frit 254 is installed into the frit housing 232, a second molding process may be utilized to secure the frit 254 in the frit housing 232 and to provide a compliant surface for allowing an interference fit seal between the sidewall inner face 208 and a complementary wall of a battery cover (not shown). First, thermoplastic rubber may be over-molded onto the frit retainer wall lower face 248 (which serves as a polypropylene substrate) and the portions of the frit 254 itself that are closely associated with the frit retainer wall lower face 248 to form a frit seal 256. The frit seal 256 is generally washer-shaped (the form of a disc with a central circular aperture) and serves to extend from the frit retainer wall lower face 248 over the edges of the frit 254 to retain the frit 254 in position within the frit housing 232. Of course, other portions of the frit retainer wall 242 and frit 254 may be over-molded to cause the desired retention of the frit 254 within the frit housing 232. By producing the frit seal through over-molding, cumbersome and expensive processes such as ultrasonic welding, hot plate melting, or other forms of adhesion are avoided. Further, the injection molding process for forming the battery vent 200 can be reduced to a simple two shot process where the polypropylene (or other suitable over-molding substrate) portion of the battery vent 200 (shown in FIGS. 7-10) is produced in a first shot and the frit seal and a vent seal 258 (discussed infra) are produced by injection of thermoplastic rubber in a second over-molded shot. Of course, where this two shot process is used, the frit 254 is inserted into the frit housing 232 between the occurrence of the first shot and the second shot.

As mentioned above, the battery vent 200 further comprises a vent seal 258 which serves as an intermediary compliant substance between the sidewall inner face 208 and a battery cover (not shown) during an interference fit between the two. More specifically, during the second shot of the two shot injection molding process described above, the vent seal 258 is deposited on the sidewall inner face 208. The vent seal 258 is formed of thermoplastic rubber (as is the frit seal 256) and is shaped as a wall having substantially uniform thickness extending from the plate inner face 214 to the sidewall lower face 212.

In operation, the battery vent 200 is used to interface a battery cover (not shown). More specifically, the sidewall 204 and associated vent seal 258 are placed in an interference fit with complementary walls of a battery cover (not shown) in such a manner that the vent seal 258 prevents unintentional escape of the battery gasses between the battery cover and the sidewall 204. Instead, the gases are allowed to escape the battery through a vent hole (not shown) in the battery cover into the chamber 202, subsequently through the frit 254, and finally through the vent channel 252. Of course, gases may be allowed to enter the battery through the same path but in reverse order, effectively allowing the battery to breath. Further, as the battery vent 200 is finally positioned relative to the complementary battery cover, locking tabs (not shown) on the battery cover engage apertures 222 to lock the battery vent 200 in place. Slots 228 serve to allow elastic deformation of the retainer barrel 220 as necessary to engage the locking tabs.

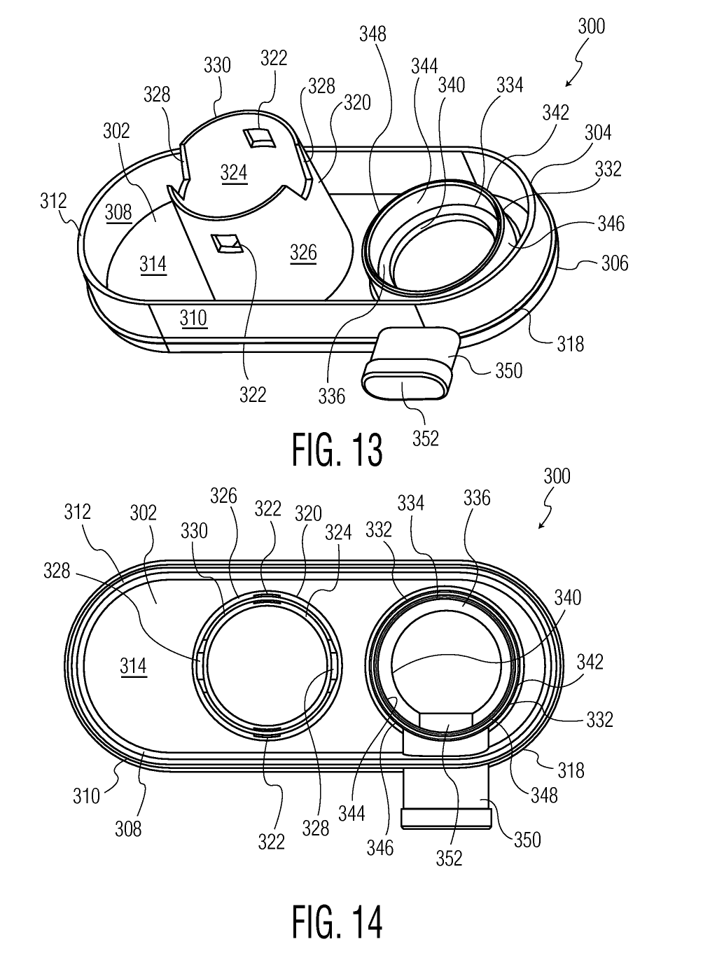

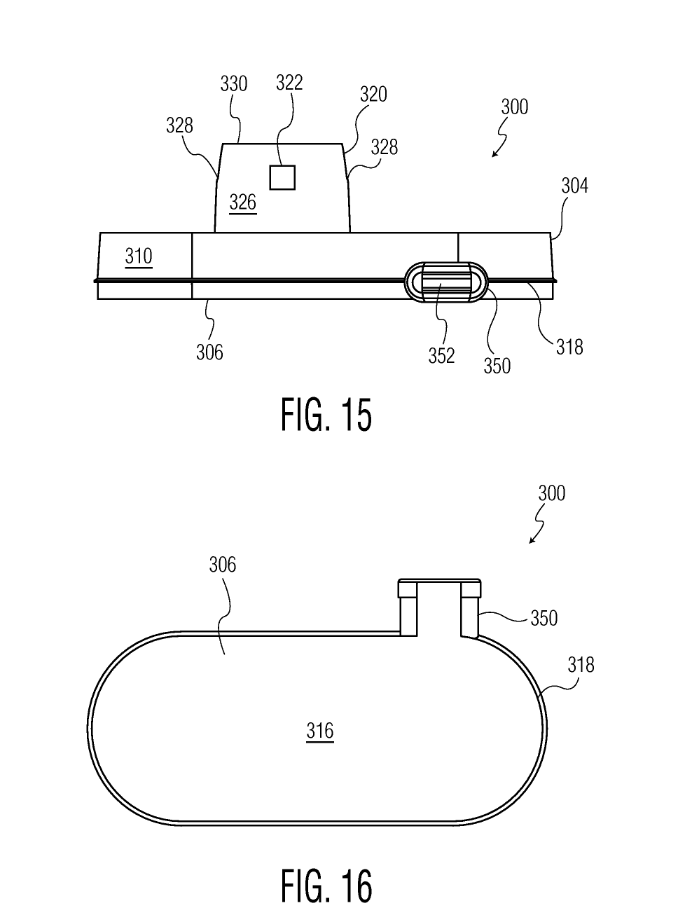

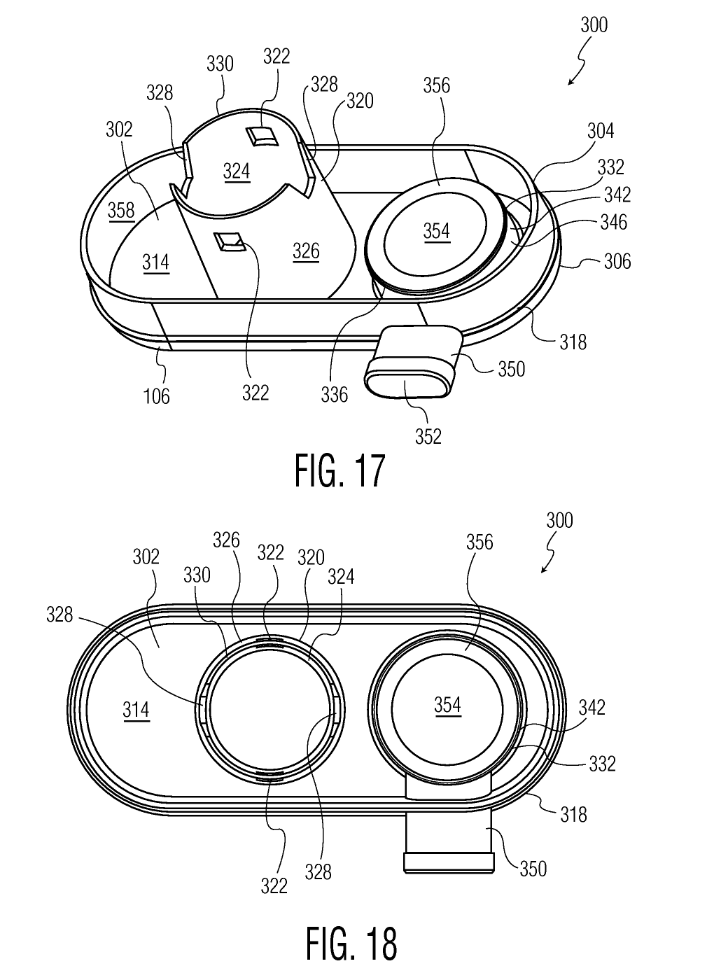

Referring to FIGS. 13-18, a battery vent 300 according to another embodiment of the present invention is illustrated. More specifically, the battery vent 300 is shown in a partially constructed state in FIGS. 13-16 while the battery vent 300 is shown in a fully constructed state in FIGS. 17 and 18.

Referring now to FIGS. 13-16, the battery vent 300 comprises a chamber 302 bounded generally by a sidewall 304 and a plate 306 that is attached to the sidewall 304. Sidewall 304 is generally upstanding with a periphery that approximates a ‘racetrack’ or two truncated circles joined by straight lines. The sidewall 304 comprises a sidewall inner face 308, a sidewall outer face 310, and a sidewall lower face 312. A sidewall upper face (not shown) is generally abutted and attached to a plate inner face 314 of plate 306. When assembled with the remainder of a battery (not shown), a plate outer face 316 is exposed to the environment exterior to the battery. The plate 306 is generally a flat member of constant thickness and comprises a periphery that approximates a ‘racetrack’ or two truncated circles joined by straight lines. As shown attached to the sidewall 304, the plate 306 generally extends to the periphery of the sidewall 304 and a seating lip 318 is formed substantially at the intersection of the sidewall 304 and the plate 306. The seating lip 318 may serve to interface a shoulder or other stop of a battery cover (not shown). Sidewall 304 has a varying thickness and is generally thickest near plate 306 and thinnest at sidewall lower face 312.

A retainer barrel 320 extends from the plate inner face 314 through the chamber 302 and beyond the sidewall lower face 312. The retainer barrel 320 is generally shaped as a frusto-conical tube where the larger diameter portion of the frustum is attached to the plate inner face 314 and the smaller diameter portion of the frustum lies outside the chamber 302 and beyond the sidewall lower face 312. The retainer barrel 320 comprises a barrel inner face 324 and a barrel outer face 326. Two diametrically opposing apertures 322 are formed in the retainer barrel 320 through the tubular wall, extending between a barrel inner face 324 and a barrel outer face 326. The apertures 322 are generally rectangular. Further, two diametrically opposing slots 328 are formed in the retainer barrel 320, also extending between the barrel inner face 324 and the barrel outer face 326. Each slot 328 is generally shaped as a truncated V where the open portion of the V is generally coplanar with a barrel lower face 330.

A generally cylindrical frit housing 332 is adjacent the retainer barrel 320 and extends from the plate inner face 314. However, unlike the retainer barrel 320, the frit housing 332 does not extend beyond the sidewall lower face 312, but is generally housed within the chamber 302. The frit housing 332 comprises a generally C-shaped frit shelf 334 that is attached to the plate inner face 314 and is positioned along a frit retainer wall inside face 344. The frit shelf 334 is oriented such that the open portion of the C-shape is directed toward a lateral side of the battery vent 300 opposite the side to which the open portion of the C-shape of battery vent 200 was directed. A frit retainer wall 342 is generally shaped as a short cylindrical tube having the frit retainer wall inside face 344, a frit retainer wall outer face 346, and a frit retainer wall lower face 348. Frit retainer wall 342 further comprises a frit retainer wall upper face (not shown) that is attached to the frit shelf lower face 336. Frit retainer wall 342 is generally coaxial with frit shelf 334. The diameter of the frit shelf inner face 340 is less than the diameter of the frit retainer wall inside face 344 while the diameter of the frit shelf outer face (not shown) is the same as the diameter of the frit retainer wall inside face 344.

A vent tube 350 for providing a vent channel 352 extends from the frit retainer wall 342, through the sidewall 304, and protrudes beyond the sidewall outer face 310 in a lateral direction with respect to the length of the battery vent 100 but in a direction opposite to the direction which the vent channel 252 extends beyond the sidewall outer face 210. The vent tube 350 is generally shaped as an elongated tube having a ‘racetrack’ cross-sectional shape. Accordingly, the vent tube 350 provides the vent channel 352 that connects the environment exterior to the battery vent 300 and an associated battery vent cover (not shown) to the space generally bounded by the frit shelf inner face 340 and the plate inner face 314. The vent channel 352 is well suited for passing gas between the environment exterior to the battery vent 300 and an associated battery vent cover (not shown) and the space generally bounded by the frit shelf inner face 340 and the plate inner face 314.

The portions of battery vent 300 shown in FIGS. 13-16 may be constructed as a unitary piece as the result of an injection molding process. More specifically, the portions of battery vent 300 shown in FIGS. 13-16 may be formed of polypropylene or other suitable molding materials in a single injection-molding step. However, the portions of battery vent 300 shown in FIGS. 13-16 may alternatively be formed by joining a plurality of distinct pieces together to form the battery vent 300 as shown in FIGS. 13-16. While the battery vent 300 as shown in FIGS. 13-16 have been described with specificity, the shapes and relative sizes of the various features of the battery vent 300 as shown in FIGS. 13-16 may be altered without straying from the inventive concepts of the invention.

Referring now to FIGS. 17 and 18, the battery vent 300 is shown in a fully assembled state. After partial construction of the battery vent 300 as shown in FIGS. 13-16, a frit 354 may be assembled to the partially constructed battery vent 300. The frit 354 is generally a flame or spark arrestor which retards the ignition of gases which may pass through the vent channel 352. The frit 354 may be constructed of porous polyethylene, porous polypropylene, or any other suitable material capable of retarding the ignition of gases passing through the vent channel 352. The frit 354 is generally disc-shaped and is complementarily sized for insertion into the frit housing 332. More specifically, the frit 354 is configured to fit within the space generally bounded by the frit shelf lower face 336 and the frit retainer wall inside face 344. After insertion of the frit 354 into the frit housing 332, gas must pass through the frit 354 to travel between the chamber 302 and the vent channel 352.

After the frit 354 is installed into the frit housing 332, a second molding process may be utilized to secure the frit 354 in the frit housing 332 and to provide a compliant surface for allowing an interference fit seal between the sidewall inner face 308 and a complementary wall of a battery cover (not shown). First, thermoplastic rubber may be over-molded onto the frit retainer wall lower face 348 (which serves as a polypropylene substrate) and the portions of the frit 354 itself that are closely associated with the frit retainer wall lower face 348 to form a frit seal 356. The frit seal 356 is generally washer-shaped (the form of a disc with a central circular aperture) and serves to extend from the frit retainer wall lower face 348 over the edges of the frit 354 to retain the frit 354 in position within the frit housing 332. Of course, other portions of the frit retainer wall 342 and frit 354 may be over-molded to cause the desired retention of the frit 354 within the frit housing 332. By producing the frit seal through over-molding, cumbersome and expensive processes such as ultrasonic welding, hot plate melting, or other forms of adhesion are avoided. Further, the injection molding process for forming the battery vent 300 can be reduced to a simple two shot process where the polypropylene (or other suitable over-molding substrate) portion of the battery vent 300 (shown in FIGS. 13-16) is produced in a first shot and the frit seal and a vent seal 358 (discussed infra) are produced by injection of thermoplastic rubber in a second over-molded shot. Of course, where this two shot process is used, the frit 354 is inserted into the frit housing 332 between the occurrence of the first shot and the second shot.

As mentioned above, the battery vent 300 further comprises a vent seal 358 which serves as an intermediary compliant substance between the sidewall inner face 308 and a battery cover (not shown) during an interference fit between the two. More specifically, during the second shot of the two shot injection molding process described above, the vent seal 358 is deposited on the sidewall inner face 308. The vent seal 358 is formed of thermoplastic rubber (as is the frit seal 356) and is shaped as a wall having substantially uniform thickness extending from the plate inner face 314 to the sidewall lower face 312.

In operation, the battery vent 300 is used to interface a battery cover (not shown). More specifically, the sidewall 304 and associated vent seal 358 are placed in an interference fit with complementary walls of a battery cover (not shown) in such a manner that the vent seal 358 prevents unintentional escape of the battery gasses between the battery cover and the sidewall 304. Instead, the gases are allowed to escape the battery through a vent hole (not shown) in the battery cover into the chamber 302, subsequently through the frit 354, and finally through the vent channel 352. Of course, gases may be allowed to enter the battery through the same path but in reverse order, effectively allowing the battery to breath. Further, as the battery vent 300 is finally positioned relative to the complementary battery cover, locking tabs (not shown) on the battery cover engage apertures 322 to lock the battery vent 300 in place. Slots 328 serve to allow elastic deformation of the retainer barrel 320 as necessary to engage the locking tabs.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A battery vent comprising:
a chamber bounded by a sidewall and a plate;
a frit housing having a retainer wall extending from the plate into the chamber to an open retainer wall lower face;
a vent tube extending outwardly from the frit housing, the vent tube having a vent channel which is open to the retainer wall inside face; and
a frit applied over the open retainer wall lower face and secured thereto by over molding.

2. The battery vent of claim 1 wherein the chamber is molded in a first molding process and the frit is over molded to the retainer wall in a second molding process.

3. The battery vent of claim 2 wherein the frit housing further comprises a frit shelf positioned therein along a retainer wall inside face.

4. The battery vent of claim 3 wherein the frit shelf is generally C shaped having an open portion thereof facing the vent channel.

5. The battery vent of claim 4 wherein a portion of the frit is received on the frit shelf.

6. The battery vent of claim 1 wherein the vent tube extends through the chamber sidewall.

7. The battery vent of claim 5 wherein the vent tube extends through the chamber sidewall in a lateral direction.

8. The battery vent of claim 1 further comprising a retainer barrel extending from the plate; the retainer barrel having two opposed apertures formed therein.

9. The battery vent of claim 2 further comprising a vent seal extending from the plate along the chamber sidewall.

10. The battery vent of claim 9 wherein the vent seal is formed by over molding.

11. The battery vent of claim 10 wherein the vent seal and frit are both over molded in the second molding process.

12. The battery vent of claim 10 wherein the vent seal is formed of thermoplastic rubber.

13. A battery vent comprising:
an integrally molded frit housing which is molded with the battery vent in a first molding process such that the frit housing has an open end and a portion being open to the outside thereof; and,
frit positioned over the open end of the frit housing and secured thereto by an over molded frit seal in a second molding process.

14. The battery vent of claim 13 wherein the frit housing comprises a retainer wall extending into a chamber of the vent to an open retainer wall lower face which receives the frit.

15. The battery vent of claim 14 further comprising a vent tube defining the portion being open to the outside and extending outwardly from the frit housing.

16. The battery vent of claim 13 wherein the frit housing is molded from a polypropylene material.

17. The battery vent of claim 13 wherein the frit seal is molded from a thermoplastic rubber material.
